(19) United States
(12) Patent Application Publication
(10) Pub. No.: US 2015/0096374 A1
(43) Pub. Date: Apr. 9, 2015

(54) ANGULAR VELOCITY SENSOR AND MANUFACTURING METHOD OF THE SAME

(71) Applicant: SAMSUNG ELECTRO-MECHANICS CO., LTD., Suwon-Si (KR)

(72) Inventors: Jong Woon Kim, Suwon-Si (KR); Jae Chang Lee, Suwon-Si (KR); Sang Kee Yoon, Suwon-Si (KR); Hyun Kee Lee, Suwon-Si (KR); Yeong Gyu Lee, Suwon-Si (KR); Seung Mo Lim, Suwon-Si (KR)

(73) Assignee: SAMSUNG ELECTRO-MECHANICS CO., LTD., Suwon-Si (KR)

(21) Appl. No.: 14/499,183

(22) Filed: Sep. 28, 2014

(30) Foreign Application Priority Data
Oct. 4, 2013 (KR) 10-2013-0118620

(51) Int. Cl. G01P 15/09

(52) U.S. Cl. CPC G01P 15/0922
USPC 73/504.12; 438/53

(57) ABSTRACT

Disclosed herein is an angular velocity sensor, including: a mass body part; an internal frame supporting the mass body part; a first flexible part each connecting the mass body part to the internal frame; a second flexible part each connecting the mass body part to the internal frame; an external frame supporting the internal frame; a third flexible part connecting the internal frame and the external frame to each other; and a fourth flexible part connecting the internal frame and the external frame to each other, wherein the internal frame, the second flexible part, and the fourth flexible part have an oxide layer formed thereon.

### CROSS REFERENCE TO RELATED APPLICATION

This application claims the benefit of Korean Patent Application No. 10-2013-0118620, filed on Oct. 4, 2013, entitled “Angular Velocity Sensor and Manufacturing Method of the Same”, which is hereby incorporated by reference in its entirety into this application.

### BACKGROUND OF THE INVENTION

1. Technical Field

The present invention relates to an angular velocity sensor and a manufacturing method of the same.

2. Description of the Related Art

Recently, an angular velocity sensor has been used in various applications, for example, military such as an artificial satellite, a missile, an unmanned aircraft, or the like, vehicles such as an air bag, electronic stability control (ESC), a black box for a vehicle, or the like, hand shaking prevention of a camcorder, motion sensing of a mobile phone or a game machine, navigation, or the like.

The angular velocity sensor generally adopts a configuration in which a mass body is adhered to an elastic substrate such as a membrane, or the like, in order to measure angular velocity. Through the configuration, the angular velocity sensor may calculate the angular velocity by measuring Coriolis force applied to the mass body.

In detail, a scheme of measuring the angular velocity using the angular velocity sensor is as follows. First, the angular velocity may be measured by Coriolis force “F=2mΩ×v”, where “F” represents the Coriolis force applied to the mass body, “m” represents the mass of the mass body, “Ω” represents the angular velocity to be measured, and “v” represents the motion velocity of the mass body. Among others, since the motion velocity v of the mass body and the mass m of the mass body are values known in advance, the angular velocity Ω may be obtained by detecting the Coriolis force (F) applied to the mass body.

Meanwhile, the angular velocity sensor according to the prior art includes a piezoelectric material disposed on a membrane (a diaphragm) in order to sense driving of a mass body or displacement of the mass body, as disclosed in Patent Document of the following Prior Art Document. In order to measure the angular velocity using the angular velocity sensor, it is preferable to allow a resonant frequency of a driving mode and a resonant frequency of a sensing mode to almost coincide with each other. However, very large interference occurs between the driving mode and the sensing mode due to a fine manufacturing error caused by a shape, stress, a physical property, or the like. Therefore, since a noise signal significantly larger than an angular velocity signal is output, circuit amplification of the angular velocity signal is limited, such that sensitivity of the angular velocity sensor is deteriorated, and air damping according to structural characteristics is generated, such that driving displacement is limited.

### PRIOR ART DOCUMENT

### Patent Document

(Patent Document 1) US20110146404 A1

### SUMMARY OF THE INVENTION

The present invention has been made in an effort to provide an angular velocity sensor including a plurality of frames to individually generate driving displacement and sensing displacement of mass bodies and including flexible parts formed so that the mass bodies are movable only in specific directions to remove interference between a driving mode and a sensing mode, decrease an effect due to a manufacturing error, and minimize air damping inevitably generated due to structural characteristics, such that driving displacement is maximized, thereby increasing sensing efficiency.

The present invention has been made in an effort to provide an angular velocity sensor capable of simplifying a process of manufacturing the angular velocity sensor as well as forming a fine pattern and improving inter-layer alignment by manufacturing the angular velocity sensor in a multi-layer structure according to a silicon direct bonding, and a manufacturing method of the same.

According to a first preferred embodiment of the present invention, there is provided an angular velocity sensor, including: a mass body part; an internal frame supporting the mass body part; a first flexible part each connecting the mass body part to the internal frame; a second flexible part each connecting the mass body part to the internal frame; an external frame supporting the internal frame; a third flexible part connecting the internal frame and the external frame to each other; and a fourth flexible part connecting the internal frame and the external frame to each other, wherein the internal frame, the second flexible part, and the fourth flexible part have an oxide layer formed thereon.

The external frame and the mass body part may have the oxide layer formed thereon.

The first flexible part and the third flexible part may be formed by a first layer substrate, the second flexible part, the fourth flexible part, and the internal frame may be formed by the first layer substrate and a second layer substrate, and the mass body part and the external frame may be formed by the first layer substrate, the second layer substrate, and a third layer substrate.

The first layer substrate and the second layer substrate may be formed of an SOI wafer, the third layer substrate may be formed of a Si wafer, and the SOI wafer and the Si wafer may be coupled to each other by a silicon direct bonding method.

The second layer substrate and the third layer substrate may have the oxide layer formed therebetween.

The first layer substrate and the second layer substrate may have the oxide layer formed therebetween.

The third layer substrate may have an external frame pattern layer and a mass body part pattern layer formed thereon.

The first flexible part may be a beam having a surface formed by one axis and the other axis direction and a thickness extended in a direction perpendicular to the surface.

The second flexible part may be a hinge having a thickness in one axis direction and having a surface formed in the other axis direction.

The third flexible part may be a beam having a surface formed by one axis and the other axis direction and a thickness extended in a direction perpendicular to the surface.

The fourth flexible part may be a hinge having a thickness in one axis direction and having a surface formed in the other axis direction.

The first flexible part and the second flexible part may be disposed in a direction perpendicular to each other, and the third flexible part and the fourth flexible part may be disposed in a direction perpendicular to each other.

The third flexible part may be disposed in a direction perpendicular to the first flexible part.

The fourth flexible part may be disposed in a direction perpendicular to the second flexible part.

The first flexible part or the second flexible part may have a sensing unit provided on one surface thereof, where the sensing unit may sense displacement of the mass body part.

The third flexible part or the fourth flexible part may have a driving unit provided on one surface thereof, where the driving unit may drive the internal frame.

The mass body part may be configured by a first mass body and a second mass body having the same size and shape.

According to a second preferred embodiment of the present invention, there is provided an angular velocity sensor, including: a mass body part; an internal frame supporting the mass body part; a first flexible part each connecting the mass body part to the internal frame; a second flexible part each connecting the mass body part to the internal frame; an external frame supporting the internal frame; a third flexible part connecting the internal frame and the external frame to each other; and a fourth flexible part connecting the internal frame and the external frame to each other, wherein the external frame and the mass body part have an oxide layer formed thereon.

The first flexible part and the third flexible part may be formed by a first layer substrate, the second flexible part, the fourth flexible part, and the internal frame may be formed by the first layer substrate and a second layer substrate, and the mass body part and the external frame may be formed by the first layer substrate, the second layer substrate, and a third layer substrate.

The first layer substrate and the second layer substrate may be formed of an SOI wafer, the third layer substrate may be formed of a Si wafer, and the SOI wafer and the Si wafer may be coupled to each other by a silicon direct bonding method.

The first layer substrate and the second layer substrate forming the mass body part may have the oxide layer formed therebetween, and the second layer substrate and the third layer substrate forming the external frame may have the oxide layer formed therebetween.

The first flexible part may be a beam having a surface formed by one axis and the other axis direction, and a thickness extended in a direction perpendicular to the surface, and the second flexible part may be a hinge having a thickness in one axis direction and having a surface formed in the other axis direction.

The third flexible part may be a beam having a surface formed by one axis and the other axis direction, and a thickness extended in a direction perpendicular to the surface, and the fourth flexible part may be a hinge having a thickness in one axis direction and having a surface formed in the other axis direction.

According to a first preferred embodiment of the present invention, there is provided a manufacturing method of an angular velocity sensor, the method including: forming an oxide layer, and flexible part and internal frame patterns on an SOI wafer; forming the oxide layer, and mass body part and external frame patterns on an Si wafer; coupling the SOI wafer and the Si wafer to each other; and etching the SOI wafer and the Si wafer.

In the coupling of the SOI wafer and the Si wafer, the SOI wafer and the Si wafer may be coupled to each other by a silicon direct bonding method.

In the etching of the SOI wafer and the Si wafer, the SOI wafer and the Si wafer may be sequentially etched through the oxide layer of the SOI wafer and the oxide layer of the Si wafer to thereby form a mass body, an external frame, the flexible part, and an to internal frame.

According to a second preferred embodiment of the present invention, there is provided a manufacturing method of an angular velocity sensor, the method including: preparing an SOI wafer; forming an oxide layer, flexible part and internal frame patterns, and mass body part and external frame patterns on an Si wafer; coupling the SOI wafer and the Si wafer to each other; and etching the SOI wafer and the Si wafer.

In the coupling of the SOI wafer and the Si wafer, the SOI wafer and the Si wafer may be coupled to each other by a silicon direct bonding method.

In the etching of the SOI wafer and the Si wafer, the Si wafer and the SOI wafer may be sequentially etched through the oxide layer of the Si wafer to thereby form a mass body, an external frame, the flexible part, and an internal frame.

According to a third preferred embodiment of the present invention, there is provided a manufacturing method of an angular velocity sensor, the method comprising: forming an oxide layer or a photoresist layer, and flexible part and internal frame patterns on an SOI wafer; coupling an Si wafer to the SOI wafer and forming an oxide layer or the photoresist layer, and mass body part and external frame patterns on the Si wafer; and etching the SOI wafer and the Si wafer.

In the coupling of the SOI wafer and the Si wafer, the SOI wafer and the Si wafer may be coupled to each other by a silicon direct bonding method.

In the etching of the SOI wafer and the Si wafer, the Si wafer and the SOI wafer may be sequentially etched through the oxide layer or the photoresist layer of the SOI wafer and the oxide layer or the photoresist layer of the Si wafer to thereby form the mass body, an external frame, the flexible part, and an internal frame.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of an angular velocity sensor according to a first preferred embodiment of the present invention;

FIG. 2 is a plan view of the angular velocity sensor shown in FIG. 1;

FIG. 3 is a schematic cross-sectional view taken along a line A-A of the angular velocity sensor shown in FIG. 2;

FIG. 4 is a schematic cross-sectional view taken along a line B-B of the angular velocity sensor shown in FIG. 2;

FIG. 5 is a schematic cross-sectional view taken along a line C-C of the angular velocity sensor shown in FIG. 1;

FIG. 6 is a schematic cross-sectional view according to another preferred embodiment of the present invention of a mass body part and an external frame in the angular velocity sensor according to the first preferred embodiment of the present invention;

FIG. 7 is a plan view showing movable directions of a mass body part and an internal frame in the angular velocity sensor shown in FIG. 2;

FIG. 8 is a schematic first cross-sectional view of an angular velocity sensor according to a second preferred embodiment of the present invention;

FIG. 9 is a schematic second cross-sectional view of the angular velocity sensor according to the second preferred embodiment of the present invention;

FIGS. 10A to 10D are process views schematically showing a manufacturing method of an angular velocity sensor according to a first preferred embodiment of the present invention;

FIGS. 11A to 11D are process views schematically showing a manufacturing method of an angular velocity sensor according to a second preferred embodiment of the present invention; and

FIGS. 12A to 12C are process views schematically showing a manufacturing method of an angular velocity sensor according to a third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, one side“, the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a preferred embodiment of the present invention will be described in detail with reference to the accompanying drawings.

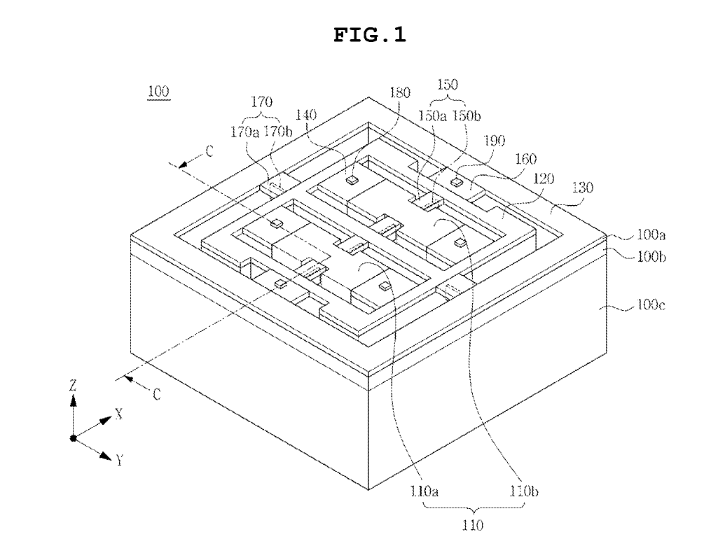

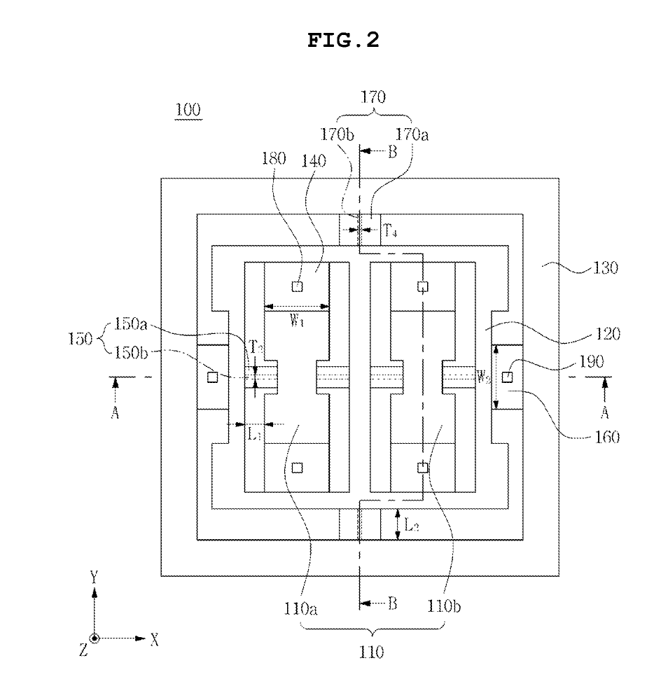

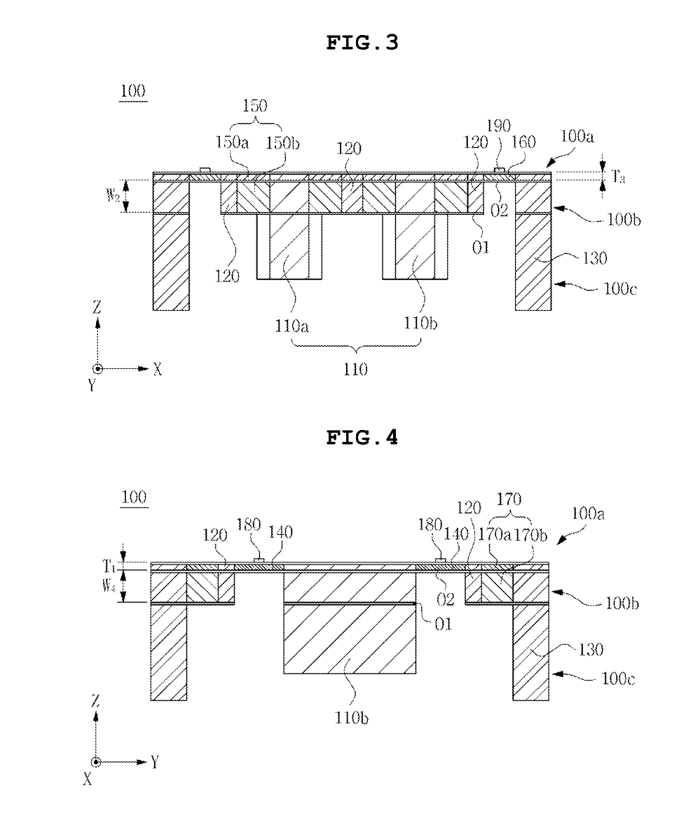

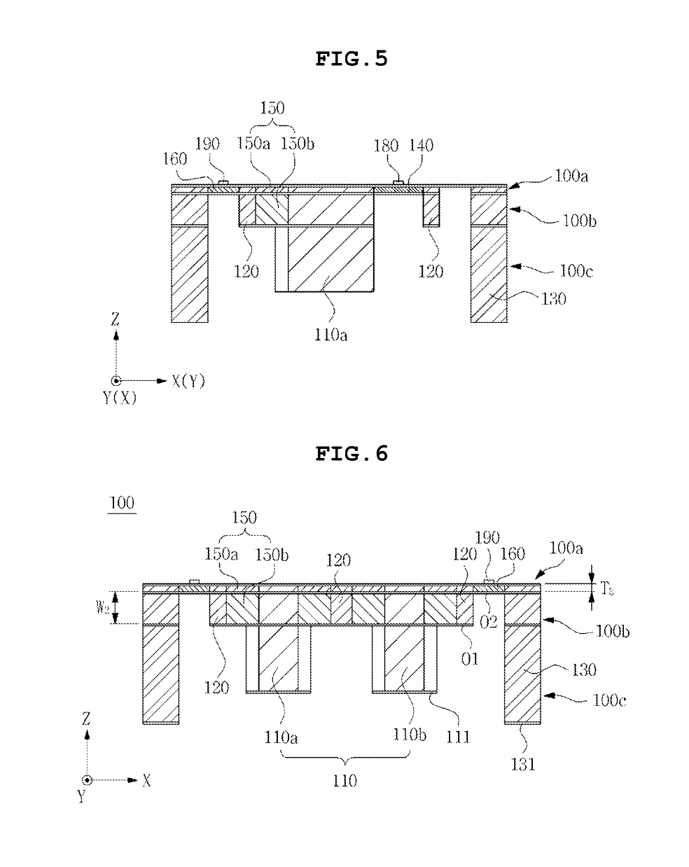

FIG. 1 is a perspective view of an angular velocity sensor according to a first preferred embodiment of the present invention, FIG. 2 is a plan view of the angular velocity sensor shown in FIG. 1, FIG. 3 is a schematic cross-sectional view taken along a line A-A of the angular velocity sensor shown in FIG. 2, FIG. 4 is a schematic cross-sectional view taken along a line B-B of the angular velocity sensor shown in FIG. 2, and FIG. 5 is a schematic cross-sectional view taken along a line C-C of the angular velocity sensor shown in FIG. 1.

As shown, the angular velocity sensor 100 is configured to include a mass body part 110, an internal frame 120, an external frame 130, a first flexible part 140, a second flexible part 150, a third flexible part 160, and a fourth flexible part 170. In addition, the internal frame 120, the second flexible part 150, and the fourth flexible part 170 have an oxide layer O1 formed thereon.

In addition, the first flexible part 140 and the second flexible part 150 selectively include a sensing unit 180, and the third flexible part 160 and the fourth flexible part 170 selectively include a driving unit 190.

More specifically, the angular velocity sensor 100 according to the preferred embodiment of the present invention is configured by a first layer substrate 100a, a second layer substrate 100b, and a third layer substrate 100c which are a three-layer substrate along a stacked direction, that is, a Z-axis direction in order to form the above-mentioned components.

In addition, the oxide layer O1 may be each formed between the second layer substrate 100b and the third layer substrate 100c. In addition, an oxide layer O2 may be formed between the first layer substrate 100a and the second layer substrate 100b.

In addition, the first flexible part 140 and the third flexible part 160 are formed by the first layer substrate 100a, the second flexible part 150, the fourth flexible part 170, and the internal frame 120 are formed by the first layer substrate 100a and the second layer substrate 100b, and the mass body part 110 and the external frame 130 are formed by the first layer substrate 100a, the second layer substrate 100b, and the third layer substrate 100c.

In addition, as shown in FIG. 6, the third layer substrate 100c may have a mass body part pattern layer 111 and an external frame pattern layer 131 formed for forming the mass body part and the external frame.

In addition, the first layer substrate 100a and the second layer substrate 100b of the angular velocity sensor 100 may be formed by an SOI wafer, the third layer substrate 100c may be formed by a Si wafer, and the SOI wafer and the Si wafer may be coupled by a silicon direct bonding method.

Hereinafter, the respective components and an organic coupling thereof of the angular velocity sensor 100 according to the preferred embodiment of the present invention will be described in more detail.

More specifically, the mass body part 110, which is displaced by Coriolis force, includes a first mass body 110a and a second mass body 110b having the same size and shape.

In addition, the first mass body 110a and the second mass body 110b are connected to the second flexible part 150 so as to correspond to the center of gravity at the central portion.

In addition, the first mass body 110a and the second mass body 110b are connected to the internal frame 120 by the first flexible part 140 and the second flexible part 150.

In addition, the first mass body 110a and the second mass body 110b are displaced based on the internal frame 120 by bending of the first flexible part 140 and twisting of the second flexible part 150 when Coriolis force acts thereon. In this case, the first mass body 110a is rotated based on an X axis with respect to the internal frame 120. A detailed content associated with this will be described below.

Meanwhile, although the case in which the first mass body 110a and the second mass body 110b have a generally square pillar shape is shown, the first mass body 110a and the second mass body 110b are not limited to having the above-mentioned shape, but may have all shapes known in the art.

In addition, the first and second mass bodies 110a and 110b have a generally square pillar shape and first step parts (not shown) depressed so as to be stepped inwardly may be formed.

In addition, the first step parts are formed at connection parts at which the first and second mass bodies 110a and 110b are connected to the second flexible part 150, respectively, which is to increase a length of the second flexible part 150, thereby increasing displacement and detection sensitivity of the first and second mass bodies 110a and 110b.

In addition, second step parts (not shown) for preventing deterioration of sensitivity according to air damping of the mass body are further formed at connection part sides at which the first and second mass bodies 110a and 110b are connected to the first flexible part 130, respectively. In addition, the second step parts are formed at connection parts at which to the first and second mass bodies 110a and 110b are connected to the first flexible part 140, respectively, which is to increase a length of the first flexible part 140, thereby increasing displacement and detection sensitivity of the first and second mass bodies 110a and 110b.

In addition, the first and second mass bodies 110a and 110b have the first flexible part 140 connected to each of both end portions with respect to the Y axis direction and the second flexible part 150 connected to each of both end portion with respect to the X axis direction. In this case, the second flexible part 150 may be connected to the first step parts of the first and second mass body 110a and 110b.

In addition, the first flexible part 140 and the second flexible part 150 connected to the first and second mass bodies 110a and 110b, respectively are connected to the internal frame 120, such that the first and second mass bodies 110a and 110b are supported by the internal frame 120. To this end, the internal frame 120 may have the mass body part 110 embedded therein and is connected to the mass body part 110 by the first flexible part 140 and the second flexible part 150.

More specifically, the internal frame 120 is partitioned into two space parts 120a and 120b so that the first mass body 110a and the second mass body 110b may be embedded.

In addition, the internal frame 120 secures a space in which the first mass body 110a and the second mass body 110b connected by the first flexible part 140 and the second flexible part 150 may be displaced and becomes a basis when the first mass body 110a and the second mass body 110b are displaced.

In addition, the internal frame 120 may be formed so as to have the same thickness as the second flexible part 150.

In addition, the internal frame 120 may be formed so as to cover only a portion of the mass body part 110. In addition, the internal frame 120 may have a square pillar shape in which it has a square pillar shaped cavity formed at the center thereof, but is not limited thereto.

Next, the external frame 130 supports the internal frame 120. More specifically, the external frame 130 is provided at an outer side of the internal frame 120 so that the internal frame 120 is spaced, and is connected to the internal frame 120 by the third flexible part 160 and the fourth flexible part 170. Therefore, the internal frame 120 and the mass body part 110 connected to the internal frame 120 are supported by the external frame 130 in a floating state so as to be displaceable. In addition, the external frame 130 may be formed so as to cover only a portion of the internal frame 120.

In addition, the mass body part 110 and the external frame 130 may have a pattern layer 131 for forming the mass body part and the external frame formed at lower end portion thereof.

In addition, the sensing unit 180 and the driving unit 190 are each formed on one surface of the first flexible part 140 and the third flexible part 160 according to a preferred embodiment of the present invention.

In addition, the third flexible part 140 is a beam having a predetermined thickness in a Z axis direction and having a surface formed by the X axis and the Y axis. That is, the first flexible part is formed so as to have a width W₁ in the X axis direction larger than a thickness T₁ in the Z axis direction.

In addition, the first flexible part may be provided with the sensing unit 180. That is, when viewing based on an X-Y plane, since the first flexible part 140 is relatively wide as compared to the second flexible part 150, the first flexible part 140 may be provided with the sensing unit 180 sensing the displacement of the first mass body 110a and the second mass body 110b.

In addition, the sensing unit 180 may be formed in a piezoelectric scheme, a piezoresistive scheme, a capacitive scheme, an optical scheme, or the like, but is not particularly limited thereto.

In addition, the second flexible part 150 is configured of a second flexible beam part 150a formed by the first layer substrate 100a and a second flexible hinge part 150b formed by the second layer substrate 100b. In addition, the second flexible hinge part 150b is a hinge having a predetermined thickness in the Y axis direction and having a surface formed by the X axis and the Z axis. That is, the second flexible hinge part 150b may be formed so as to have a width W₂ in the Z axis direction larger than a thickness T₂ in the Y axis direction.

In addition, the second flexible part 150 may be disposed so as to correspond to the center of gravity of the mass body part 110. This is the reason that when the second flexible part 150 which is a rotation axis of the mass body part 110 is spaced apart from the center of gravity of the mass body part 110, the inertial force acting in the Z axis direction to the mass body part 110 which is driven in the Z axis generates the displacement of the mass body part 110 even in a situation in which no angular velocity is input, thereby causing noise.

In addition, the first flexible part 140 and the second flexible part 150 are disposed in a direction perpendicular to each other. That is, the first flexible part 140 is coupled to the mass body part 110 and the internal frame 120 in the Y axis direction, and the second flexible part 150 is coupled to the mass body part 110 and the internal frame 120 in the X axis direction.

Through the above-mentioned configuration, since the second flexible hinge part 150b has the width W₂ in the Z axis direction larger than the thickness T₂ in the Y axis direction, the first and second mass bodies 110a and 110b are limited from being rotated based on the Y axis or translated in the Z axis direction, but may be relatively freely rotated based on the X axis. That is, the first and second mass bodies 110a and 110b are embedded in the internal frame 120 to be thereby rotated based on the X axis direction, and the second flexible part 150 serves as a hinge for the above-mentioned rotation.

In addition, the external frame 130 is positioned at an outer side of the internal frame 120 so as to be spaced apart from the internal frame 120, and is connected to the internal frame 120 by the third flexible part 160 and the fourth flexible part 170.

In addition, the external frame 130 supports the third flexible part 160 and the fourth flexible part 170 to allow a space in which the internal frame 120 may be displaced to be secured and becomes a basis when the internal frame 120 is displaced. In addition, the external frame 130 may have a square pillar shape in which it has a square pillar shaped cavity formed at the center thereof, but is not limited thereto.

In addition, the third flexible part 160 is a beam having a predetermined thickness in a Z axis direction and having a surface formed by the X axis and the Y axis. That is, the third flexible part 160 is formed so as to have a width W₃ in the Y axis direction larger than a thickness T₃ in the Z axis direction.

Meanwhile, the third flexible part 160 may be disposed in a direction perpendicular to the first flexible part 140.

In addition, the third flexible part 160 has the driving unit 190 formed thereon, where the driving unit 190, which is to drive the internal frame 120 and the mass body par 110, may be formed so as to use a piezoelectric scheme, a capacitive scheme, or the like.

In addition, the fourth flexible part 170 is configured of a fourth flexible beam part 170a formed by the first layer substrate 100a and a fourth flexible hinge part 170b formed by the second layer substrate 100b. In addition, the fourth flexible hinge part 170b is a hinge having a predetermined thickness in the X axis direction and having a surface formed by the Y axis and the Z axis. That is, the fourth flexible part 170 is formed so as to have a width W₄ in the Z axis direction larger than a thickness T₄ in the X axis direction.

In addition, the third flexible part 160 and the fourth flexible part 170 are disposed in a direction perpendicular to each other. That is, the third flexible part 160 is coupled to the internal frame 120 and the external frame 130 in the X axis direction, and the fourth flexible part 170 is coupled to the internal frame 120 and the external frame 130 in the Y axis direction.

In addition, the fourth flexible part may be disposed so as to correspond to the center of gravity of the second mass body. This is the reason that when the fourth flexible part which is a driving rotation axis of the internal frame is spaced apart from the center of gravity of the second mass body, the inertial force acting to the second mass body in the Z axis generates the displacement of the second mass body even in a situation in which no angular velocity is input, thereby causing noise.

In addition, the third and fourth flexible parts 160 and 170 connect the external frame 130 and the internal frame 120 to each other so that the internal frame 120 may be displaced based on the external frame 130.

That is, the third flexible part 160 connects the internal frame 120 and the external frame 130 to each other in the X axis direction, and the fourth flexible part 170 connects the internal frame 120 and the external frame 130 to each other in the Y axis direction.

In addition, when viewing based on the X-Y plane, since the third flexible part 160 is relatively wide as compared to the fourth flexible part 170, the third flexible part 160 may be provided with the driving unit 190 driving the internal frame 120.

Here, the driving unit 190 may drive the internal frame 120 so as to be rotated based on the Y axis. In this case, the driving unit 190 may be formed so as to use a piezoelectric scheme, a capacitive scheme, or the like, but is not particularly limited thereto.

In addition, since the fourth flexible part 170 has a width W₄ in the Z axis direction larger than a thickness T₄ in the X axis direction as described above, the internal frame 120 is limited from being rotated based on the X axis or translated in the Z axis direction, but may be relatively freely rotated based on the Y axis. That is, the internal frame 120 is fixed to the external frame 130 so as to be rotated based on the Y axis direction, and the fourth flexible part 170 serves as a hinge for the rotation of the internal frame 120.

In addition, as the first flexible part 140, the second flexible part 150, the third flexible part 160, and the fourth flexible part 170 are disposed as describe above, the first flexible part 140 and the third flexible part 160 may be disposed in a direction perpendicular to each other. In addition, the second flexible part 150 and the fourth flexible part 170 may be disposed in a direction perpendicular to each other.

Meanwhile, the first flexible part 140 and the third flexible part 160 may be disposed so as to be in parallel with each other.

In addition, the second flexible hinge part 150b and the fourth flexible hinge part 170 of the angular velocity sensor according to the preferred embodiment of the present invention may be formed in all possible shapes such as a hinge shape having a rectangular cross section, a torsion bar shape having a circular cross section, and the like.

In addition, the angular velocity sensor according to the first preferred embodiment of the present invention may be configured by a technical configuration forming the driving unit on the fourth flexible part, without including the third flexible part.

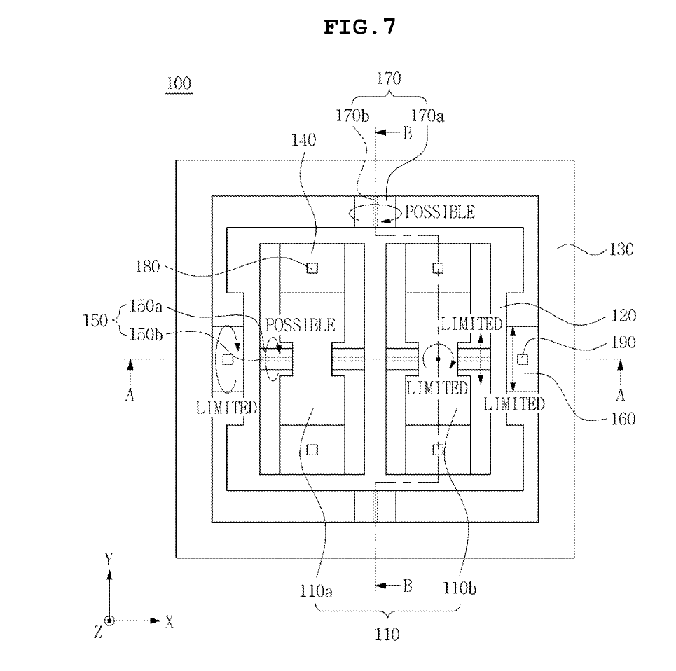

FIG. 7 is a plan view showing movable directions of a mass body part and an internal frame in the angular velocity sensor shown in FIG. 2.

First, since the second flexible hinge part 150b has the width W₂ in the Z axis direction larger than the thickness T₂ in the Y axis direction, the first mass body 110a and the second mass body 110b are limited from being rotated based on the Y axis or translated in the Z axis direction, but may be relatively freely rotated based on the X axis, with respect to the internal frame 120.

Specifically, in the case in which rigidity of the second flexible hinge part 150b at the time of rotation based on the Y axis is larger than rigidity of the second flexible hinge part 150b at the time of rotation based on the X axis, the first mass body 110a and second mass body 110b may be freely rotated based on the X axis, but are limited from being rotated based on the Y axis.

Similarly, in the case in which rigidity of the second flexible hinge part 150b at the time of translation in the Z axis direction is larger than the rigidity of the second flexible hinge part 150b at the time of the rotation based on the X axis, the first mass body 110a and the second mass body 110b may be freely rotated based on the X axis, but are limited from being translated in the Z axis direction.

Therefore, as a value of (the rigidity of the second flexible hinge part 150b at the time of the rotation based on the Y axis or the rigidity of the second flexible hinge part 150b at the time of the translation in the Z axis direction)/(the rigidity of the second flexible hinge part 150b at the time of the rotation based on the X axis) increases, the first mass body 110a and the second mass body 110b may be freely rotated based on the X axis, but are limited from being rotated based on the Y axis or translated in the Z axis direction, with respect to the internal frame 120.

Relationships among the width W₂ of the second flexible hinge part 150b in the Z axis direction, a length L₁ thereof in the X axis direction, the thickness T₂ thereof in the Y axis direction, and the rigidities thereof in each direction may be represented by the following Equations.

(1) The rigidity of the second flexible hinge part 150b at the time of the rotation based on the Y axis or the rigidity thereof at the time of the translation in the Z axis direction is ∝W₂³×T₂/L₁³,

(2) The rigidity of the second flexible hinge part 150b at the time of the rotation based on the X axis is ∝T₂³×W₂/L₁.

According to the above two Equations, the value of (the rigidity of the second flexible hinge part 150b at the time of the rotation based on the Y axis or the rigidity of the second flexible hinge part 150b at the time of the translation in the Z axis direction)/(the rigidity of the second flexible hinge part 150b at the time of the rotation based on the X axis) is in proportion to (W₂/(T₂L₁))². However, since the second flexible hinge part 150b has the width W₂ in the Z axis direction larger than the thickness T₂ in the Y axis direction, (W₂/(T₂L₁))² is large, such that the value of (the rigidity of the second flexible hinge part 150b at the time of the rotation based on the Y axis or the rigidity of the second flexible hinge part 150b at the time of the translation in the Z axis direction)/(the rigidity of the second flexible hinge part 150b at the time of the rotation based on the X axis) increases. Due to these characteristics of the second flexible part 150, the first mass body 110a and the second mass body 110b are freely rotated based on the X axis, but are limited from being rotated based on the Y axis or translated in the Z axis direction, with respect to the internal frame 120.

Meanwhile, the first flexible part 140 has relatively very high rigidity in the length direction (the Y axis direction), thereby making it possible to limit the first mass body 110a and the second mass body 110b from being rotated based on the Z axis or translated in the Y axis direction with respect to the internal frame 120.

In addition, the second flexible hinge part 150b has relatively very high rigidity in the length direction (the X axis direction), thereby making it possible to limit the first mass body 110a and the second mass body 110b from being translated in the X axis direction with respect to the internal frame 120.

As a result, due to the characteristics of the first flexible part 140 and the second flexible hinge part 150b described above, the first mass body 110a and the second mass body 110b may be rotated based on the X axis, but are limited from being rotated based on the Y or Z axis or translated in the Z, Y, or X axis direction, with respect to the internal frame 120. That is, the movable directions of the first mass body 110a and the second mass body 110b may be represented by the following Table 1.

TABLE 1

| Movable Directions of First Mass Body | |
|---|---|
| and Second Mass Body (Based on Internal | Whether or not movement is |
| Frame) | possible |
| Rotation based on X axis | Possible |
| Rotation based on Y axis | Limited |
| Rotation based on Z axis | Limited |
| Translation in X axis direction | Limited |
| Translation in Y axis direction | Limited |
| Translation in Z axis direction | Limited |

As described above, since the first mass body 110a and second mass body 110b may be rotated based on the X axis, that is, the second flexible hinge part 150b, but are limited from being moved in the remaining directions, with respect to the internal frame 120, the first mass body 110a and the second mass body 110b may be allowed to be displaced only with respect to force in a desired direction (the rotation based on the X axis).

In addition, since first mass body 110a and the second mass body 110b are rotated based on the X axis with the respect to the internal frame 120, as the first mass body 110a and the second mass body 110b are rotated based on an axis to which the second flexible part is coupled, with respect to the internal frame, bending stress in which compression stress and tension stress are combined with each other is generated in the first flexible part 140, and twisting stress is generated based on the X axis in the second flexible part 150.

In addition, the bending stress of the first flexible part 140 is detected by the sensing unit 180.

Next, since the fourth flexible hinge part 170b has the width W₄ in the Z axis direction larger than the thickness T₄ in the X axis direction, the internal frame 120 is limited from being rotated based on the X axis or translated in the Z axis direction, but is relatively freely rotated based on the Y axis, with respect to the external frame 130.

Specifically, in the case in which rigidity of the fourth flexible hinge part 170b at the time of rotation based on the X axis is larger than rigidity of the fourth flexible hinge part 170b at the time of rotation based on the Y axis, the internal frame 120 may be freely rotated based on the Y axis, but is limited from being rotated based on the X axis. Similarly, in the case in which rigidity of the fourth flexible hinge part 170b at the time of translation in the Z axis direction is larger than the rigidity of the fourth flexible hinge part 170 at the time of the rotation based on the Y axis, the internal frame 120 may be freely rotated based on the Y axis, but is limited from being translated in the Z axis direction.

Therefore, as a value of (the rigidity of the fourth flexible hinge part 170b at the time of the rotation based on the X axis or the rigidity of the fourth flexible hinge part 170b at the time of the translation in the Z axis direction)/(the rigidity of the fourth flexible hinge part 170b at the time of the rotation based on the Y axis) increases, the internal frame 120 is freely rotated based on the Y axis, but is limited from being rotated based on the X axis or translated in the Z axis direction, with respect to the external frame 130.

That is, relationships among the width W₄ of the fourth flexible hinge part 170b in the Z axis direction, a length L₂ thereof in the Y axis direction, the thickness T₄ thereof in the X axis direction, and the rigidities thereof in each direction may be represented by the following Equations.

(1) The rigidity of the fourth flexible hinge part 170b at the time of the rotation based on the X axis or the rigidity thereof at the time of the translation in the Z axis direction is ∝T₄×W₄³/L₂³,

(2) The rigidity of the fourth flexible hinge part 170b at the time of the rotation based on the Y axis is ∝T₄³W₄/L₂.

According to the above two Equations, the value of (the rigidity of the fourth flexible hinge part 170b at the time of the rotation based on the Y axis or the rigidity of the fourth flexible hinge part 170b at the time of the translation in the Z axis direction)/(the rigidity of the fourth flexible hinge part 170b at the time of the rotation based on the Y axis) is in proportion to (W₄/(T₄L₂))².

However, since the fourth flexible hinge part 170 has the width W₄ in the Z axis direction larger than the thickness T₄ in the X axis direction, (W₄/(T₄L₂))² is large, such that the value of (the rigidity of the fourth flexible hinge part 170b at the time of the rotation based on the X axis or the rigidity of the fourth flexible hinge part 170b at the time of the translation in the Z axis direction)/(the rigidity of the fourth flexible hinge part 170b at the time of the rotation based on the Y axis) increases. Due to above-mentioned characteristics of the fourth flexible hinge part 170b, the internal frame 120 is rotated based on the Y axis, but is limited from being rotated based on the X axis or translated in the Z axis direction, with respect to the external frame 130, and is rotated only based on the Y axis.

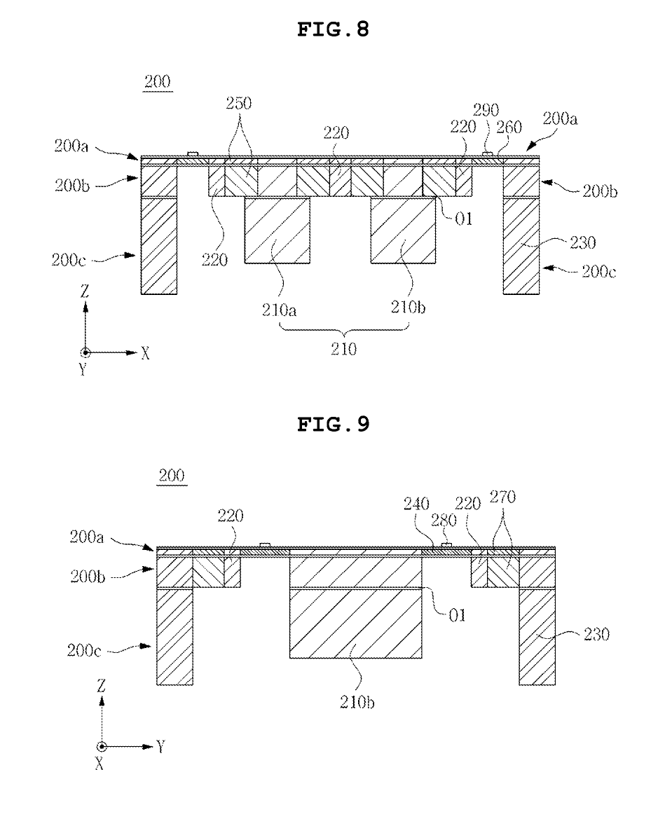

Meanwhile, the third flexible part 160 has relatively very high rigidity in the length direction (the X axis direction), thereby making it possible to limit the internal frame 120 from being rotated based on the Z axis or translated in the Z axis direction, with respect to the external frame 130. In addition, the fourth flexible part 170 has relatively very high rigidity in the length direction (the Y axis direction), thereby making it possible to limit the internal frame 120 from being translated in the Y axis direction, with respect to the external frame 130 (see FIG. 8).

As a result, due to the characteristics of the third flexible part 160 and the fourth flexible hinge part 170b described above, the internal frame 120 may be rotated based on the Y axis, but is limited from being rotated based on the X or Z axis or translated in the Z, Y, or X axis direction, with respect to the external frame 130. That is, the movable directions of the internal frame 120 may be represented by the following Table 2.

TABLE 2

| Movable Directions of the Internal Frame | Whether or not movement is |
|---|---|
| (Based on the External Frame) | possible |
| Rotation based on X axis | Limited |
| Rotation based on Y axis | Possible |
| Rotation based on Z axis | Limited |
| Translation in X axis direction | Limited |
| Translation in Y axis direction | Limited |
| Translation in Z axis direction | Limited |

As described above, since the internal frame 120 may be rotated based on the Y axis, but is limited from being moved in the remaining directions, with respect to the external frame 130, the internal frame 120 may be allowed to be displaced only with respect to force in a desired direction (the rotation based on the Y axis).

In addition, since the internal frame 120 is rotated based on the Y axis with respect to the external frame 130, that is, is rotated based on the fourth flexible hinge part 170b hinge-coupling the internal frame 120 to the external frame 130, bending stress in which compression stress and tension stress are combined with each other is generated in the third flexible part 160, and twisting stress is generated based on the Y axis in the fourth flexible hinge part 170b.

The angular velocity sensor according to the first preferred embodiment of the present invention is configured as described above. Hereinafter, a method of measuring an angular velocity by the angular velocity sensor 100 will be described in detail.

First, the internal frame 120 is rotated based on the Y axis with respect to the external frame 130 using the driving unit 190. In this case, the first mass body 110a and the second mass body 110b vibrate while being rotated together with the internal frame 120 based on the Y axis, and displacement is generated in the first mass body 110a and the second mass body 110b in response to the vibration.

Specifically, displacement (+X, −Z) in a +X axis direction and a −Z axis direction is generated in the first mass body 110a and at the same time, displacement (+X, +Z) in the +X axis direction and a +Z axis direction is generated in the second mass body 110b. Then, displacement (−X, +Z) in a −X axis direction and the +Z axis direction is generated in the first mass body 110a and at the same time, displacement (−X, −Z) in the −X axis direction and the −Z axis direction is generated in the second mass body 110b. In this case, when angular velocity which is rotated based on the X or Z axis is applied to the first mass body 110a and the second mass body 110b, Coriolis force is generated.

Due to the Coriolis force, the first mass body 110a and the second mass body 110b are displaced while being rotated based on the X axis with respect to the internal frame 120, and the sensing unit 180 senses the displacement of the first mass body 110a and the second mass body 110b.

More specifically, when angular velocity which is rotated based on the X axis is applied to the first mass body 110a and the second mass body 110b, Coriolis force is generated in a −Y axis direction and then generated in a +Y axis direction in the first mass body 110a, and Coriolis force is generated in the +Y axis direction and then generated in the −Y axis direction in the second mass body 110b.

Therefore, the first mass body 110a and the second mass body 110b are rotated based on the X axis in directions opposite to each other, the sensing unit 180 may sense the displacement of the first mass body 110a and the second mass body 110b to calculate the Coriolis force, and angular velocity which is rotated based on the X axis may be measured by the Coriolis force.

Meanwhile, when signals each generated in the first flexible part 140 and the sensing unit 180 each connected to both end portions of the first mass body 110a are defined as SY1 and SY2 and signals each generated in the first flexible part 140 and the sensing unit 180 each connected to both end portions of the second mass body 110b are defined as SY3 and SY4, the angular velocity which is rotated based on the X axis direction may be calculated from (SY1−SY2)−(SY3−SY4). As described above, since the signals are differentially output between the first mass body 110a and the second mass body 110b rotated in the directions opposite to each other, acceleration noise may be offset.

In addition, when angular velocity which is rotated based on the Z axis is applied to the first mass body 110a and the second mass body 110b, Coriolis force is generated in a −Y axis direction and then generated in a +Y axis direction in the first mass body 110a, and Coriolis force is generated in the −Y axis direction and then generated in the +Y axis direction in the second mass body 110b. Therefore, the first mass body 110a and the second mass body 110b are rotated based on the X axis in the same direction as each other, the sensing unit 180 may sense the displacement of the first mass body 110a and the second mass body 110b to calculate the Coriolis force, and angular velocity which is rotated based on the Z axis may be measured by the Coriolis force.

In this case, when signals each generated in two first flexible parts 140 and the sensing unit 180 each connected to both end portions of the first mass body 110a are defined as SY1 and SY2 and signals each generated in the first flexible part 140 and the sensing unit 180 each connected to both end portions of the second mass body 110b are defined as SY3 and SY4, the angular velocity which is rotated based on the Z axis may be calculated from (SY1−SY2)+(SY3−SY4).

In addition, an example of calculating the angular velocity according to the above-mentioned definition is as follows.

As described above, when the internal frame 120 is rotated based on the Y axis with respect to the external frame 130 by the driving unit 190, the first mass body 110a is vibrated while being rotated based on the Y axis together with the internal frame 120 and the first mass body 110a generates velocity (Vₓ, V_{z}) in the X axis and the Z axis in response to the vibration. In this case, when angular velocity (Ω_{z}, Ωₓ) based on the Z axis or the X axis is applied to the first mass body 110a, Coriolis force F_{y} is generated in the Y axis direction.

Due to the Coriolis force F_{y}, the first mass body 110a is displaced while being rotated based on the X axis with respect to the internal frame 120, and the sensing unit 180 senses the displacement of the first mass body 110a. In addition, the Coriolis force F_{y} may be calculated by sensing the displacement of the first mass body 110a.

Therefore, angular velocity Ωₓ based on the X axis may be calculated by the Coriolis force F_{y} from F_{y}=2 mV_{z}Ωₓ and angular velocity Ω_{z} based on the Z axis may be calculated by the Coriolis force F_{y} from F_{y}=2 mVₓΩ_{z}.

As a result, the angular velocity sensor 100 according to the first preferred embodiment of the present invention may measure the angular velocity which is rotated based on the X or Z axis by the sensing unit 180.

FIG. 8 is a schematic first cross-sectional view of an angular velocity sensor according to a second preferred embodiment of the present invention and FIG. 9 is a schematic second cross-sectional view of an angular velocity sensor according to a second preferred embodiment of the present.

As shown, the angular velocity sensor 200 has a difference only in a remaining structure of an oxide layer as compared to the angular velocity sensor 100 according to the first preferred embodiment of the present invention shown in FIGS. 3 and 4. That is, the oxide layer exposed to the outside in the oxide layer shown in FIGS. 3 and 4 is removed.

More specifically, the angular velocity sensor 200 is configured to include a mass body part 210, an internal frame 220, an external frame 230, a first flexible part 240, a second flexible part 250, a third flexible part 260, and a fourth flexible part 270.

In addition, the first flexible part 240 and the second flexible part 250 selectively include a sensing unit 280, and the third flexible part 260 and the fourth flexible part 270 selectively include a driving unit 290.

In addition, the angular velocity sensor 200 according to the preferred embodiment of the present invention is configured by a first layer substrate 200a, a second layer substrate 200b, and a third layer substrate 200c which are a three-layer substrate along a stacked direction, that is, a Z-axis direction in order to form the above-mentioned components.

In addition, the first flexible part 240 and the third flexible part 260 is formed by the first layer substrate 200a, the second flexible part 250, the fourth flexible part 270, and the internal frame 220 are formed by the first layer substrate 200a and the second layer substrate 200b, and the mass body part 210 and the external frame 230 are formed by the first layer substrate 200a, the second layer substrate 200b, and the third layer substrate 200c.

In addition, an oxide layer O1 is formed between the second layer substrate 200b and the third layer substrate 200c forming the mass body part 210, an oxide layer O1 is formed between the second layer substrate 200b and the third layer substrate 200c forming the external frame.

Hereinafter, since the respective component is the same as those of the angular velocity sensor according to the first preferred embodiment of the present invention, a detail description thereof will be omitted.

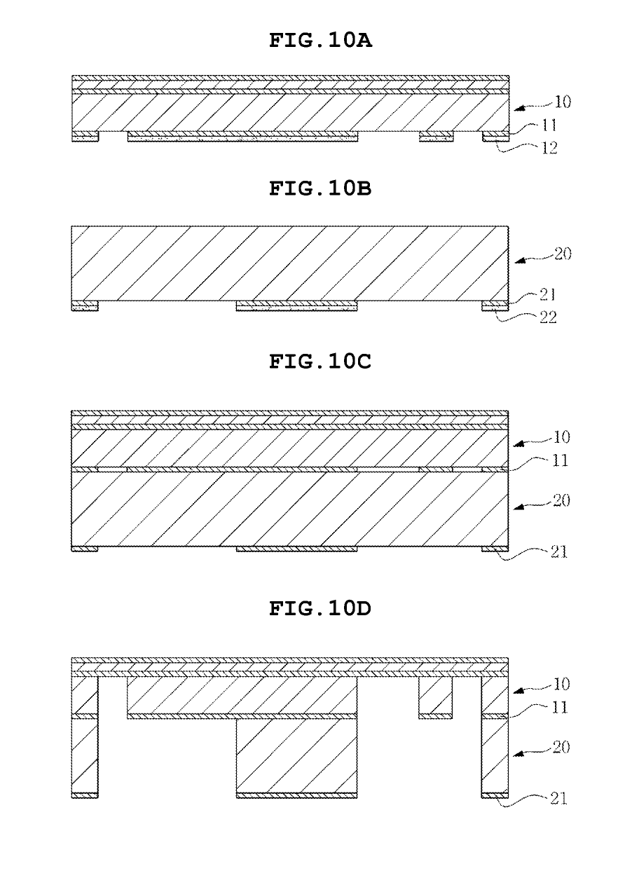

FIGS. 10A to 10D are process views schematically showing a manufacturing method of an angular velocity sensor according to a first preferred embodiment of the present invention.

As shown, FIG. 10A shows a step of forming an oxide layer, and flexible part and internal frame patterns on an SOI wafer, where an oxide layer 11 is formed by oxidizing an SOI wafer 10 forming a first layer substrate and a second layer substrate. In addition, the flexible part and the internal frame pattern 12 are formed on the oxide layer 11, and the oxide layer 11 remains so as to correspond to the flexible part and an internal frame by the flexible part and the internal frame pattern 12.

Next, FIG. 10B shows a step of forming an oxide layer, and mass body part and external frame patterns on an Si wafer, where an oxide layer 21 is formed by oxidizing an Si wafer 20 forming a third layer substrate. In addition, the mass body part and external frame patterns 22 are formed on the oxide layer 21, and the oxide layer 21 remains so as to correspond to the mass body part and an external frame by the mass body part and external frame patterns 22.

Next, FIG. 10C shows a step of coupling the SOI wafer 10 and the Si wafer 20 to each other, where the SOI wafer 10 and the Si wafer 20 are coupled to each other. In this case, at the time of the coupling, the SOI wafer 10 and the Si wafer 20 may be coupled by a silicon direct bonding method.

Next, FIG. 10D shows a step of etching the Si wafer and the SOI wafer, where the Si wafer 20 and the SOI wafer 10 are sequentially etched through the oxide layer 11 of the SOI wafer 10 and the oxide layer of the Si wafer 20 to thereby form a mass body, an external frame, the flexible part, and an internal frame.

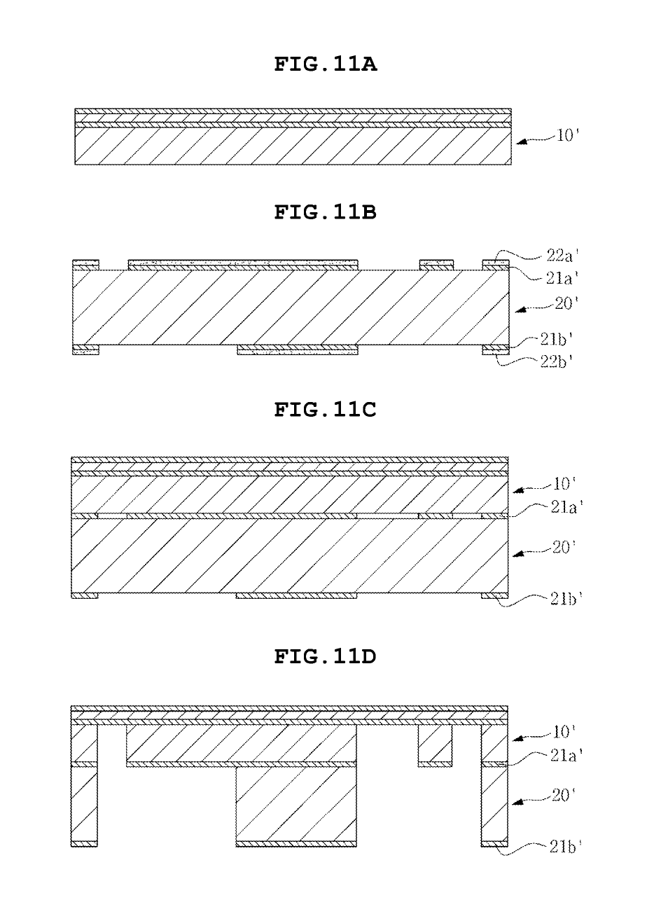

FIGS. 11A to 11D are process views schematically showing a manufacturing method of an angular velocity sensor according to a second preferred embodiment of the present invention.

As shown, FIG. 11A shows a step of preparing an SOI wafer, where an SOI wafer 10′ forming a first layer substrate and a second layer substrate is prepared.

Next, FIG. 11B shows a step of forming an oxide layer, flexible part and internal frame patterns, and mass body part and external frame patterns on an Si wafer, where oxide layers 21a′ and 21b′ are formed on both surfaces by oxidizing the Si wafer 20′ forming a third layer substrate. In addition, flexible part and internal frame patterns 22a′ are formed on the oxide layer 21a′ of an upper surface opposite to the SOI wafer 10′, and mass body part and external frame patterns 22b′ are formed on the oxide layer 21b′ of a lower surface. In addition, the oxide layers 21a′ and 21b′ remain so as to correspond to the flexile part, an internal frame, the mass body part, and an external frame.

Next, FIG. 11C shows a step of coupling the SOI wafer 10′ and the Si wafer 20′ to each other, where the SOI wafer 10′ and the Si wafer 20′ are coupled to each other. In this case, the SOI wafer 10′ and the Si wafer 20′ may be coupled by a silicon direct bonding method.

Next, FIG. 11D shows a step of etching the Si wafer and the SOI wafer, where the Si wafer 20′ and the SOI wafer 10′ are sequentially etched through the oxide layers 21a′ and 21b′ of the Si wafer 20′ to thereby form a mass body, the external frame, the flexible part, and the internal frame.

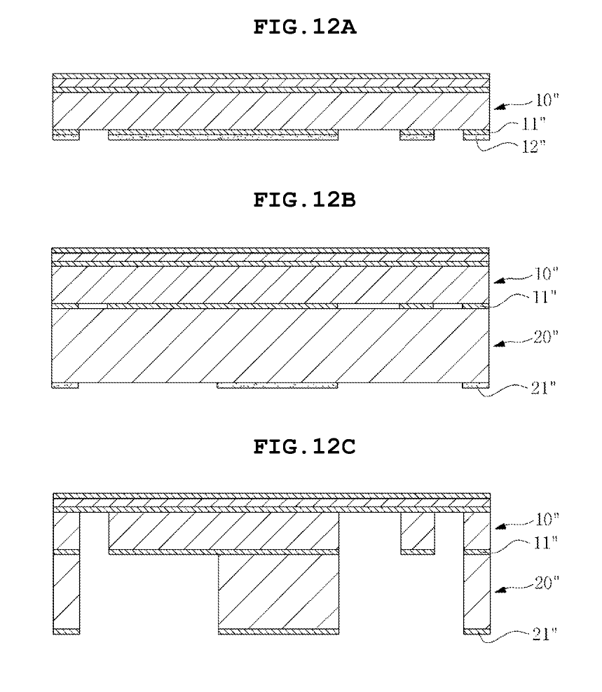

FIGS. 12A to 12C are process views schematically showing a manufacturing method of an angular velocity sensor according to a third preferred embodiment of the present invention.

As shown, FIG. 12A shows a step of forming an oxide layer, and flexible part and internal frame patterns on an SOI wafer, where an oxide layer 11″ or a photoresist layer is formed by oxidizing an SOI wafer 10″ forming a first layer substrate and a second layer substrate. In addition, the flexible part and an internal frame pattern 12″ are formed on the oxide layer 11″. In addition, the oxide layer 11″ remains so as to correspond to the flexible part and an internal frame by flexible part and internal frame patterns 12″.

Next, FIG. 12B shows a step of coupling the Si wafer and forming mass body part and external frame patterns, where a third layer substrate is coupled to the SOI wafer 10″ formed by the step of FIG. 12A to thereby form mass body part and external frame patterns 21″.

Next, FIG. 12C shows a step of etching the Si wafer and the SOI wafer, where the Si wafer 20 and the SOI wafer 10″ are sequentially etched through the oxide layer 11″ of the SOI wafer 10″ and the mass body part and external frame patterns 21″ of the Si wafer 20″ to thereby form a mass body, the external frame, the flexible part, and the internal frame.

In addition, in FIGS. 10D and 11D, an oxide layer exposed to the outside may be further selectively etched.

In addition, in FIG. 12C, an oxide layer, and the mass body part and external frame patterns 21″ exposed to the outside may be further selectively etched.

By manufacturing the angular velocity sensor according to the preferred embodiment of the present invention using the methods as mentioned-above, a fine pattern may be formed, an inter-layer alignment may be improved, and a process may be simplified.

According to the preferred embodiments of the present invention, it is possible to obtain an angular velocity sensor including a plurality of frames to individually generate driving displacement and sensing displacement of mass bodies and including flexible parts formed so that the mass bodies are movable only in specific directions to remove interference between a driving mode and a sensing mode, decrease an effect due to a manufacturing error, and minimize air damping inevitably generated due to structural characteristics, such that driving displacement is maximized, thereby increasing sensing efficiency, and it is possible to obtain an angular velocity sensor capable of simplifying a process of manufacturing the angular velocity sensor as well as forming a fine pattern and improving inter-layer alignment by manufacturing the angular velocity sensor in a multi-layer structure according to a silicon direct bonding, and a manufacturing method of the same.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements to should be considered to be within the scope of the invention, and the detailed scope of the invention will be disclosed by the accompanying claims.

What is claimed is:

1. An angular velocity sensor, comprising:
a mass body part;
an internal frame supporting the mass body part;
a first flexible part each connecting the mass body part to the internal frame;
a second flexible part each connecting the mass body part to the internal frame;
an external frame supporting the internal frame;
a third flexible part connecting the internal frame and the external frame to each other; and
a fourth flexible part connecting the internal frame and the external frame to each other,
wherein the internal frame, the second flexible part, and the fourth flexible part have an oxide layer formed thereon.

2. The angular velocity sensor as set forth in claim 1, wherein the external frame and the mass body part have the oxide layer formed thereon.

3. The angular velocity sensor as set forth in claim 1, wherein the first flexible part and the third flexible part are formed by a first layer substrate,
the second flexible part, the fourth flexible part, and the internal frame are formed by the first layer substrate and a second layer substrate, and
the mass body part and the external frame are formed by the first layer substrate, the second layer substrate, and a third layer substrate.

4. The angular velocity sensor as set forth in claim 3, wherein the first layer substrate and the second layer substrate are formed of an SOI wafer,
the third layer substrate is formed of an Si wafer, and
the SOI wafer and the Si wafer are coupled to each other by a silicon direct bonding method.

5. The angular velocity sensor as set forth in claim 4, wherein the second layer substrate and the third layer substrate have the oxide layer formed therebetween.

6. The angular velocity sensor as set forth in claim 4, wherein the first layer substrate and the second layer substrate have the oxide layer formed therebetween.

7. The angular velocity sensor as set forth in claim 3, wherein the third layer substrate has an external frame pattern layer and a mass body part pattern layer formed thereon.

8. The angular velocity sensor as set forth in claim 1, wherein the first flexible part is a beam having a surface formed by one axis and the other axis direction and a thickness extended in a direction perpendicular to the surface.

9. The angular velocity sensor as set forth in claim 1, wherein the second flexible part is a hinge having a thickness in one axis direction and having a surface formed in the other axis direction.

10. The angular velocity sensor as set forth in claim 1, wherein the third flexible part is a beam having a surface formed by one axis and the other axis direction, and a thickness extended in a direction perpendicular to the surface.

11. The angular velocity sensor as set forth in claim 1, wherein the fourth flexible part is a hinge having a thickness in one axis direction and having a surface formed in the other axis direction.

12. The angular velocity sensor as set forth in claim 1, wherein the first flexible part and the second flexible part are disposed in a direction perpendicular to each other, and the third flexible part and the fourth flexible part are disposed in a direction perpendicular to each other.

13. The angular velocity sensor as set forth in claim 1, wherein the third flexible part is disposed in a direction perpendicular to the first flexible part.

14. The angular velocity sensor as set forth in claim 1, wherein the fourth flexible part is disposed in a direction perpendicular to the second flexible part.

15. The angular velocity sensor as set forth in claim 1, wherein the first flexible part or the second flexible part has a sensing unit provided on one surface thereof, the sensing unit sensing displacement of the mass body part.

16. The angular velocity sensor as set forth in claim 1, wherein the third flexible part or the fourth flexible part has a driving unit provided on one surface thereof, the driving unit driving the internal frame.

17. The angular velocity sensor as set forth in claim 1, wherein the mass body part is configured by a first mass body and a second mass body having the same size and shape.

18. An angular velocity sensor, comprising:
a mass body part;
an internal frame supporting the mass body part;
a first flexible part each connecting the mass body part to the internal frame;
a second flexible part each connecting the mass body part to the internal frame;
an external frame supporting the internal frame;
a third flexible part connecting the internal frame and the external frame to each other; and
a fourth flexible part connecting the internal frame and the external frame to each other,
wherein the external frame and the mass body part have an oxide layer formed thereon.

19. The angular velocity sensor as set forth in claim 18, wherein the first flexible part and the third flexible part are formed by a first layer substrate,
the second flexible part, the fourth flexible part, and the internal frame are formed by the first layer substrate and a second layer substrate, and
the mass body part and the external frame are formed by the first layer substrate, the second layer substrate, and a third layer substrate.

20. The angular velocity sensor as set forth in claim 19, wherein the first layer substrate and the second layer substrate are formed of an SOI wafer, and
the third layer substrate is formed of an Si wafer, and
the SOI wafer and the Si wafer are coupled to each other by a silicon direct bonding method.

21. The angular velocity sensor as set forth in claim 19, wherein the first layer substrate and the second layer substrate forming the mass body part have the oxide layer formed therebetween, and the second layer substrate and the third layer substrate forming the external frame have the oxide layer formed therebetween.

22. The angular velocity sensor as set forth in claim 19, wherein the first flexible part is a beam having a surface formed by one axis and the other axis direction, and a thickness extended in a direction perpendicular to the surface, and
the second flexible part is a hinge having a thickness in one axis direction and having a surface formed in the other axis direction.

23. The angular velocity sensor as set forth in claim 19, wherein the third flexible part is a beam having a surface formed by one axis and the other axis direction, and a thickness extended in a direction perpendicular to the surface, and
the fourth flexible part is a hinge having a thickness in one axis direction and having a surface formed in the other axis direction.

24. A manufacturing method of an angular velocity sensor, the method comprising:
forming an oxide layer, and flexible part and internal frame patterns on an SOI wafer;
forming the oxide layer, and mass body part and external frame patterns on an Si wafer;
coupling the SOI wafer and the Si wafer to each other; and
etching the SOI wafer and the Si wafer.

25. The method as set forth in claim 24, wherein in the coupling of the SOI wafer and the Si wafer, the SOI wafer and the Si wafer is coupled to each other by a silicon direct bonding method.

26. The method as set forth in claim 24, wherein in the etching of the SOI wafer and the Si wafer, the Si wafer and the SOI wafer are sequentially etched through the oxide layer of the SOI wafer and the oxide layer of the Si wafer to thereby form a mass body, an external frame, the flexible part, and an internal frame.

27. A manufacturing method of an angular velocity sensor, the method comprising:
preparing an SOI wafer;
forming an oxide layer, flexible part and internal frame patterns, and mass body part and external frame patterns on an Si wafer;
coupling the SOI wafer and the Si wafer to each other; and
etching the SOI wafer and the Si wafer.

28. The method as set forth in claim 27, wherein in the coupling of the SOI wafer and the Si wafer, the SOI wafer and the Si wafer is coupled to each other by a silicon direct bonding method.

29. The method as set forth in claim 27, wherein in the etching of the SOI wafer and the Si wafer, the Si wafer and the SOI wafer are sequentially etched through the oxide layer of the Si wafer to thereby form a mass body, an external frame, the flexible part, and an internal frame.

30. A manufacturing method of an angular velocity sensor, the method comprising:
forming an oxide layer or a photoresist layer, and flexible part and internal frame patterns on an SOI wafer;
coupling an Si wafer to the SOI wafer and forming an oxide layer or the photoresist layer, and mass body part and external frame patterns on the Si wafer; and
etching the SOI wafer and the Si wafer.

31. The method as set forth in claim 30, wherein in the coupling of the Si wafer to the SOI wafer, the SOI wafer and the Si wafer is coupled to each other by a silicon direct bonding method.

32. The method as set forth in claim 30, wherein in the etching of the SOI wafer and the Si wafer, the Si wafer and the SOI wafer are sequentially etched through the oxide layer or the photoresist layer of the SOI wafer and the oxide layer or the photoresist layer of the Si wafer to thereby form the mass body, an external frame, the flexible part, and an internal frame.
